(19) United States
(12) Patent Application Publication
(10) Pub. No.: US 2014/0030415 A1
(43) Pub. Date: Jan. 30, 2014

(54) Refrigerated Pourable Dessert Liquid Product Concentrate

(71) Applicant: Rich Products Corporation, Buffalo, NY (US)

(72) Inventors: Arnaud Paul Serge Chamoin, Juarez (MX); Arturo Janovitz Klapp, Miguel Hidalgo (MX); Alberto Roca Mayorga, Metepec (MX)

(73) Assignee: Rich Products Corporation, Buffalo, NY (US)

(21) Appl. No.: 13/952,881

(22) Filed: Jul. 29, 2013

Related U.S. Application Data
(60) Provisional application No. 61/677,051, filed on Jul. 30, 2012.

(51) Int. Cl. A23C 9/154

(52) U.S. Cl. CPC A23C 9/1548
USPC 426/585

(57) ABSTRACT

The present invention is directed to a liquid food product and method for manufacturing the liquid product having an increase refrigerator life and ambient temperature shelf life without having to be UHT processed. The invention is also directed to a high solids content pourable dessert base product and method for manufacturing the product having at least 45-75% of total solids content.

The present invention claims priority on U.S. Patent Application Ser. No. 61/677,051 filed Jul. 30, 2012, which is incorporated herein by reference.

The present invention is directed to a liquid food product, particularly to a liquid food product that has increased shelf and/or storage life, more particularly to a liquid food product that has increased refrigerator shelf life and ambient temperature shelf life, and still more particularly to a concentrated liquid dairy-based food product that has increased refrigerator shelf life and ambient temperature shelf life.

### BACKGROUND OF THE INVENTION

Mixtures of dairy components for incorporation into food products are known in the food industry. These food products include nutritious drink mixes and dessert cakes, such as a sponge cake soaked with a blend of three milks and then decorated with a topping. One such dessert product is marketed under the trade name known as “Tres Leches” in Latin America. The dairy mix for such dessert products is traditionally prepared through laboriously blending three milk products, i.e., whole milk, sweetened condensed milk, and evaporated milk.

The current Latin American market of “Tres Leches” syrups is mostly composed of ready-to-use products. Tres Leches ready-to-use syrups are also usually either frozen products or ambient stable ultra-high-temperature (UHT) processed products. However, frozen products are inadequate for customers without freezing capacity. The UHT processed products are generally expensive for customers looking for a low-cost solution. Furthermore, many retail bakeries in Latin America possess their own proprietary Tres Leches recipe which, in addition to the traditional three milk products mixed in different proportions, often includes other custom ingredients such as sour cream, flavoring agents, vanilla extracts, liquors, etc. This personal proportion of the three milk products and this addition of custom ingredients allow retail bakeries to differentiate themselves from each other and to have their own customized Tres Leches flavor profile and sweetness level. Yet, the current Tres Leches ready-to-use products have a very limited ability to deliver a customizable flavor and sweetness for this type of customer, such as retail bakeries.

In view of the current state of the art, there remains a need for a dairy containing product such as, but not limited to, a pourable dessert liquid product that has increased refrigerator life or ambient temperature shelf life without having to be UHT processed.

### SUMMARY OF THE INVENTION

The present invention is directed to a liquid food product and method for manufacturing the liquid food product having an increased refrigerator life and ambient temperature shelf life without having to be UHT processed. The liquid food product is particularly applicable to dairy based liquid food products and will be described with particular reference thereto; however, it will be appreciated that the invention can be applied to liquid food products that do not contain dairy ingredients. The invention is also directed to a high solids content pourable dessert base product that has at least 45-75% of total solids content, that is ready-to-dilute with purified water and ready-to-mix with additional ingredients (e.g., milk, cream, flavors, extracts, liquors, etc.) for a customizable final flavor and sweetness, that has increased refrigerator shelf life and ambient temperature shelf life, and that does not require to be UHT processed or to be stored at freezing temperature. One non-limiting liquid product in accordance with the present invention is a dairy-based liquid syrup that is used on a “Tres Leches” cake. Tres Leches” cake is one of the more popular cakes in Latin America (LA). These cakes are commonly made by a homemade method. The syrup that is poured on these cakes is a dairy-based syrup. Several years ago, Rich Products Corporation developed a freeze stable line of ready-to-use Tres Leches syrups, as well as a UHT line of ready-to-use Tres Leches syrups. Although this Rich Products Corporation product is very successful, the ready-to-use Tres Leches syrups are limited in that the product must be frozen, and in many regions in LA, freezers are not available. In an effort to overcome this limitation, Rich Products Corporation has developed a new ready-to-use Tres Leches product that overcomes this problem without having to UHT process the product. The ready-to-use Tres Leches product has one or more of the following non-limiting attributes:

1. The product is a refrigerable pourable dessert liquid product having the color, flavor and aroma of a traditional mixture of Tres Leches syrups.

2. The product is a concentrated product that can be reconstituted by adding purified water.

3. The concentrated product does not require laborious mixing during the reconstitution process.

4. The product is a base Tres Leches syrup product that can be easily blended with other ingredients (e.g., vanilla, rum, brandy, liqueurs, flavorings, spices, colorants, etc.) to customize the flavor and/or color of the product.

5. The product is a freezable product, before and after being used in the final product, with no detriment of its alimentary and sensory attributes.

6. The product has increased refrigerator shelf life (e.g., 0.5-12 months, 3-12 months, 3-6 months, etc.) without UHT processing.

7. The product has increased ambient shelf life (e.g., 0.2-6 months, 1-6 months, 1 month, etc.) without UHT processing.

8. The product is a thicker product, thus can be potentially used in many different applications, such as, but not limited to, a component for desserts such as flan and gelatin, among others.

9. The product does not require to be frozen in order to extend the life of the product beyond two (2) months since the product has a refrigeration shelf life of up to 4-8 months (e.g., 4-6 months).

10. The product does not require being UHT processed in order to extend the life of the product beyond two (2) months since the product has a refrigeration shelf life of up to 4-8 months (e.g., 4-6 months).

11. The product can provide cost savings to customers due to its concentrated form and extended shelf life.

The current Mexican and LA market of a Tres Leches syrup product is a three milk syrup that is mainly composed of frozen products or ambient stable UHT-processed products. As stated above, frozen products are inadequate for customers without freezing capacity. As also stated above, UHT-processed products are expensive for customers looking for a cost-saving solution. Many retail bakeries have personal proprietary Tres Leches recipes which often include custom flavors and/or liquors. The product of the present invention, that in one non-limiting form is a Tres Leches syrup product, is designed and formulated for sale to retail bakeries to enable the product to 1) be used as a base for a Tres Leches syrup so that the syrup can be easily customized in accordance with the different recipes used at different bakeries, 2) not be required to be frozen and still maintain an extended shelf life, and 3) not be required to be UHT processed to thereby reduce the cost of the product. These objectives were obtained by creating a concentrated Tres Leches syrup product having a lower water activity as compared to traditional Tres Leches syrup products. The concentrated Tres Leches syrup product in accordance with the present invention was found to have a very long refrigerated shelf life (up to 6-8 months) and a fair ambient shelf life (up to 1 month) without having to UHT process the product. As such, the concentrated Tres Leches syrup product of the present invention solved the freezing problem and the cost problem associated with traditional concentrated Tres Leches syrup formulations. By using the concentrated Tres Leches syrup product of the present invention as a new base flavor system, the base flavor system can be easily customized by the incorporation of additional flavors and/or liquors during the reconstitution of the product with purified water. The concentrated Tres Leches syrup product of the present invention is also very easy to blend and customize according to the personal proprietary recipe of each customer. The use of the concentrated Tres Leches syrup product of the present invention also simplifies the production process of customers (e.g., timesaving, spoilage-saving and storage-saving).

In accordance with another and/or alternative aspect of the present invention, the concentrated product of the present invention can be concentrated at various degrees of concentration. For example, the concentrated product of the present invention can be concentrated so that full reconstitution occurs when one part concentrated product of the present invention is added to 0.2-10 parts water, typically 0.5-4 parts water, and more typically 0.6-2 parts water. In one non-limiting example, the concentrated product of the present invention, when in the form of concentrated Tres Leches syrup product, can be fully reconstituted by adding 50-100 mL of purified water to 100 mL of the concentrated Tres Leches syrup product. In another non-limiting example, the concentrated product of the present invention, when in the form of concentrated Tres Leches syrup product, can be fully reconstituted by adding 75 mL of purified water to 100 mL of the concentrated Tres Leches syrup product.

In accordance with still another and/or alternative aspect of the present invention, concentrated Tres Leches syrup product can be made by a technology involving HTST pasteurization. Non-limiting formulations of the concentrated Tres Leches syrup product in accordance with the present invention are set forth as follows:

### Example 1

| Component | Weight Percent |
|---|---|
| Water | 10-60% |
| Salt | up to 8% |
| Emulsifier | up to 5% |
| Stabilizer | up to 5% |
| Dairy/Protein | 3-25% |
| Sweetener | 5-50% |
| Humectants | 0-5% |
| Oil/Fat | 2-25% |
| Color | up to 1% |
| Flavoring Agent | up to 5% |
| Preservative | up to 0.4% |

### Example 2

| Component | Weight Percent |
|---|---|
| Water | 15-50% |
| Salt | up to 5% |
| Emulsifier | up to 4% |
| Stabilizer | up to 4% |
| Dairy/Protein | 5-20% |
| Sugar | 10-40% |
| Humectants | 0-5% |
| Oil/Fat | 5-20% |
| Color | up to 1% |
| Flavoring Agent | up to 4% |
| Preservative | up to 0.3% |

### Example 3

| Component | Weight Percent |
|---|---|
| Water | 15-30% |
| Salt | up to 3% |
| Emulsifier | up to 2% |
| Stabilizer | up to 2% |
| Dairy/Protein | 8-20% |
| Sugar | 15-35% |
| Humectants | 0-5% |
| Oil/Fat | 8-15% |
| Color | up to 1% |
| Flavoring Agent | up to 4% |
| Preservative | up to 0.3% |

### Example 4

| Component | Weight Percent |
|---|---|
| Water | 10-40% |
| Salts | up to 1% |
| Emulsifiers | up to 2% |
| Stabilizers | up to 1% |
| Dairy/Proteins | 5-20% |
| Sweeteners | 30-60% |
| Humectants | 0-5% |
| Oil/Fat | 2-17% |
| Colors | up to 0.5% |
| Flavors | up to 1% |
| Preservatives | up to 0.5% |

A formulation with higher total solids content can be used as a sweetened condensed milk substitute.

The characteristics of the “Tres Leches” syrup product based on the formulation of Examples 1-4 are as follows:

| Parameter | Units | Range |
|---|---|---|
| Total Solids | % | 45-75% |
| pH | | 5.7-7.5 |
| Viscosity (4-10° C., 100 rpm, | cPs | 500-2000 |
| Spindle 4-5) | | |
| Water activity (a_{w}) | | 0.82-0.92 |

Five non-limiting specific examples of a concentrated “Tres Leches” syrup product in accordance with the present invention are set forth as follows:

### Example A

| Category | Component | Weight Percent |
|---|---|---|
| Water | Purified water | 20-40% |
| Salt | Refined salt (e.g., NaCl) | less than 1% |
| Salt | Dipotassium Phosphate | less than 1% |
| Salt | Sodium Citrate | less than 1% |
| Emulsifier | Mono-diglycerides | less than 1% |
| Stabilizer | Carrageenan | less than 1% |
| Dairy | Skim Milk Powder | 5-15% |
| Emulsifier | Polysorbate 60 | less than 1% |
| Sugar | HFCS 42 | 20-40% |
| Sugar | Glucose 36 DE | 5-15% |
| Sugar | Glycerin | 0-5% |
| Oil/Fat | Pam Oil | 5-15% |
| Color | Beta-carotene 30% | less than 0.5% |
| Flavor | Flavorings | less than 0.5% |
| Flavor | Flavor masking | less than 0.5% |
| Preservative | Natamycin | less than 0.1% |

The characteristics of the “Tres Leches” syrup product based on the formulation of Example A are as follows:

| Parameter | Units | Range |
|---|---|---|
| Fat | % | 5-15% |
| Solids | % | 50-65% |
| pH | | 6.4-6.9 |
| Viscosity (6-7° C., 100 rpm, | cPs | 600-800 |
| Spindle 4) | | |
| Water activity (aᵥ) | | less than 0.92 |

### Example B

| Category | Component | Weight Percent |
|---|---|---|
| Water | Purified water | 25-30% |
| Salt | Refined salt (e.g., NaCl) | less than 1% |
| Salt | Dipotassium Phosphate | less than 1% |
| Salt | Sodium Citrate | less than 1% |
| Emulsifier | Mono-diglycerides | less than 1% |
| Stabilizer | Carrageenan | less than 1% |
| Dairy | Skim Milk Powder | 10-15% |
| Emulsifier | Polysorbate 60 | less than 0.5% |
| Sugar | HFCS 42 | 25-30% |
| Sugar | Glucose 36 DE | 10-15% |
| Sugar | Glycerin | 0-5% |
| Oil/Fat | Pam Oil | 10-15% |
| Color | Beta-carotene 30% | less than 0.5% |
| Flavor | Flavorings | less than 0.5% |
| Flavor | Flavor masking | less than 0.5% |
| Preservative | Natamycin | less than 0.1% |

### Example C

| Category | Component | Weight Percent |
|---|---|---|
| Water | Purified water | 25-28% |
| Salt | Refined salt (e.g., NaCl) | less than 0.8% |
| Salt | Dipotassium Phosphate | less than 0.8% |
| Salt | Sodium Citrate | less than 0.8% |
| Emulsifier | Mono-diglycerides | less than 0.8% |
| Stabilizer | Carrageenan | less than 0.8% |
| Dairy | Skim Milk Powder | 12-15% |
| Emulsifier | Polysorbate 60 | less than 0.45% |
| Sugar | HFCS 42 | 25-30% |
| Sugar | Glucose 36 DE | 10-15% |
| Sugar | Glycerin | 0-5% |
| Oil/Fat | Pam Oil | 10-15% |
| Color | Beta-carotene 30% | less than 0.4% |
| Flavor | Flavorings | less than 0.4% |
| Flavor | Flavor masking | less than 0.4% |
| Preservative | Natamycin | less than 0.1% |

The characteristics of the “Tres Leches” syrup product based on the formulation of Examples B and C are as follows:

| Parameter | Units | Range |
|---|---|---|
| Fat | % | 12.5-13.5% |
| Solids | % | 56-60% |
| pH | | 6.5-6.9 |
| Viscosity (6-7° C., 100 rpm, | cPs | 600-700 |
| Spindle 4) | | |
| Water activity (aᵥ) | | less than 0.9 |

### Example D

| Category | Component | Weight Percent |
|---|---|---|
| Water | Purified water | 18-38% |
| Salt | Refined salt (e.g., NaCl) | less than 1% |
| Salt | Dipotassium Phosphate | less than 1% |
| Salt | Sodium Citrate | less than 1% |
| Emulsifier | Mono-diglycerides | less than 1% |
| Stabilizer | Carrageenan | less than 1% |
| Stabilizer | Xanthan gum | less than 1% |
| Dairy/Protein | Skim Milk Powder | 5-15% |
| Emulsifier | Polysorbate 60 | less than 1% |
| Sugar | HFCS 42 | 19-39% |
| Sugar | Glucose 36 DE | 8-18% |
| Humectant | Glycerin | 0-5% |
| Oil/Fat | Palm Kernel Oil | 6-16% |
| Color | Beta-carotene 30% | less than 0.5% |
| Flavor | Milk Flavor | less than 0.5% |
| Flavor | Masking Flavor | less than 0.5% |
| Preservative | Natamycin | less than 0.1% |

The characteristics of the “Tres Leches” syrup product based on the formulation of Example D are as follows:

| Parameter | Units | Range |
|---|---|---|
| Total Solids | % | 50-70% |
| pH | | 6.2-7.2 |
| Viscosity (4-10° C., 100 rpm, | cPs | 500-1000 |
| Spindle 4) | | |
| Water activity (a_{w}) | | 0.85-0.92 |

### Example E

| Category | Component | Weight Percent |
|---|---|---|
| Water | Purified water | 23-43% |
| Salt | Refined salt (e.g., NaCl) | less than 1% |
| Salt | Dipotassium Phosphate | less than 1% |
| Salt | Sodium Citrate | less than 1% |
| Emulsifier | Mono-diglycerides | less than 1% |
| Stabilizer | Carrageenan | less than 1% |
| Stabilizer | Xanthan gum | less than 1% |
| Dairy/Protein | Skim Milk Powder | 5-15% |
| Emulsifier | Polysorbate 60 | less than 1% |
| Sugar | Sucrose | 38-58% |
| Humectant | Glycerin | 0-5% |
| Oil/Fat | Palm Kermel Oil | 0-10% |
| Color | Beta-carotene 30% | less than 0.5% |
| Flavor | Milk Flavor | less than 0.5% |
| Flavor | Masking Flavor | less than 0.5% |
| Preservative | Natamycin | less than 0.1% |

The characteristics of this higher total solids content product that can be used as a sweetened condensed milk substitute based on the formulation of Example E are as follows:

| Parameter | Units | Range |
|---|---|---|
| Total Solids | % | 55-75% |
| pH | | 5.7-6.7 |
| Viscosity (4-10° C., 100 rpm, | cPs | 1000-2000 |
| Spindle 5) | | |
| Water activity (a_{w}) | | 0.82-0.89 |

In another non-limiting aspect of the invention, the water content of the liquid dessert concentrate is less than 50 weight percent and the sugar content of the liquid dessert concentrate is equal to or greater than the weight percent of the water in the liquid dessert concentrate. In one non-limiting formulation, the weight ratio of sugar to water in the liquid dessert concentrate 1.01-1.5:1, typically 1.05-1.3:1, and more typically 1.05-1.2:1.

In still another non-limiting aspect of the invention, the water activity of the liquid dessert concentrate is generally less than about 1, typically less than about 0.95, more typically less than about 0.9, and still more typically less than about 0.85.

In yet another non-limiting aspect of the invention, the dairy or protein content of the liquid dessert concentrate is generally greater than 8 weight percent, typically about 8.5-30 weight percent, more typically about 9-25 weight percent, and still more typically about 10-20 weight percent.

In summary, the “Tres Leches” syrup product in accordance with the present invention has the following non-limiting advantages:

1. Offers a cost-efficient and convenient product to replace the traditional three milks mixture for clients without freezing capacity;

2. Simplifies the three milks syrup production process of customers (e.g., time-saving, spoilage-saving and storage-saving);

3. Allows the customers to custom formulate the final “Tres Leches” product using the base “Tres Leches” syrup product in accordance with the present invention;

4. Avoids the need of a distribution network that involves the freezing of the product; and

5. Saves distribution and storage space.

One non-limiting objective of this invention is to provide a high solids content pourable dessert base product for use in food products, which can provide a customizable final flavor profile and sweetness level of the above-described food products.

Another non-limiting objective of this invention is to provide a high solids content pourable dessert base product that it is ready-to-dilute by adding purified water, that is ready-to-mix with additional ingredients (e.g., milk, cream, flavors, extracts, liquors, etc.), and that does not require laboriously mixing the additional water and ingredients.

Still another non-limiting objective of this invention is to provide a high solids content pourable dessert base product that has increased refrigerator shelf life and ambient temperature shelf life.

Yet another non-limiting objective of this invention is to provide a single high solids content pourable dessert base product that does not require to be UHT processed or to be stored at freezing temperature, that is consistent in quality and overall improves the sanitary and keeping quality since only a single liquid is used with no exposure to contamination as in the case of mixing the three separate milk products.

Still yet another non-limiting objective of this invention is to provide a cost-efficient and convenient product to replace the traditional three milks mixture for clients without freezing capacity.

Another non-limiting objective of this invention is to provide a method that simplifies the three milks syrup production process of customers (e.g., time-saving, spoilage-saving and storage-saving).

Still another non-limiting objective of this invention is to provide an improved pourable dessert base product.

Yet another non-limiting objective of this invention is to provide a formulation for a pourable dessert base product that allows a customer to custom formulate the final pourable dessert base product using the base pourable dessert base syrup product in accordance with the present invention.

Still yet another non-limiting objective of this invention is to provide a formulation for a pourable dessert base product that avoids the need of a distribution network that involves the freezing of the product.

Another non-limiting objective of this invention is to provide a pourable dessert base product that saves distribution and storage space.

Still another non-limiting objective of this invention is to provide a formulation for a pourable dessert base product that is a refrigerable pourable dessert liquid product having the color, flavor and aroma of a traditional mixture of Tres Leches syrups.

Yet another non-limiting objective of this invention is to provide a formulation for a pourable dessert base product that is a concentrate product that can be reconstituted by adding purified water.

Still yet another non-limiting objective of this invention is to provide a formulation for a pourable dessert base product that does not require laborious mixing during the reconstitution process.

Another non-limiting objective of this invention is to provide a formulation for a pourable dessert base product that can be easily blended with other ingredients (e.g., vanilla, rum, brandy, liqueurs, flavorings, spices, colorants, etc.) to customize the flavor and/or color of the product.

Still another non-limiting objective of this invention is to provide a formulation for a pourable dessert base product that can be a freezable product, before and after being used in the final product with no detriment of its alimentary and sensory attributes.

Yet another non-limiting objective of this invention is to provide a formulation for a pourable dessert base product that has increased refrigerator shelf life (e.g., 0.5-12 months, 3-12 months, 3-6 months, etc.) without UHT processing.

Still yet another non-limiting objective of this invention is to provide a formulation for a pourable dessert base product that has increased ambient shelf life (e.g., 0.2-6 months, 1-6 months, 1 month, etc.) without UHT processing.

Another non-limiting objective of this invention is to provide a formulation for a pourable dessert base product that is a thicker product, thus can be potentially used in many different application, such as, but not limited to, as a component for desserts such as flan and gelatin, among others.

Still another non-limiting objective of this invention isto provide a formulation for a pourable dessert base product that does not require to be frozen to extend the life of the product beyond two (2) months since the product has a refrigeration shelf life of up to 4-8 months (e.g., 4-6 months).

Yet another non-limiting objective of this invention is to provide a formulation for a pourable dessert base product that does not require it to be UHT processed to extend the life of the product beyond two (2) months since the product has a refrigeration shelf life of up to 4-8 months (e.g., 4-6 months).

Still yet another non-limiting objective of this invention is to provide a formulation for a pourable dessert base product that can provide cost savings to customers due to its concentrated form and extended shelf life. Another non-limiting objective of this invention is to provide a high solids content pourable dessert base product that can be used as a sweetened condensed milk substitute.

These and other objects and advantages will become apparent to those skilled in the art upon reading and following the description taken together with the accompanying drawing.

### BRIEF DESCRIPTION OF THE DRAWING

Reference may now be made to the drawing which illustrates information related to non-limiting embodiment of the invention:

FIG. 1 is a process diagram that illustrates one non-limiting process for manufacturing the pourable dessert base product in accordance with the present invention.

### DETAILED DESCRIPTION OF THE INVENTION

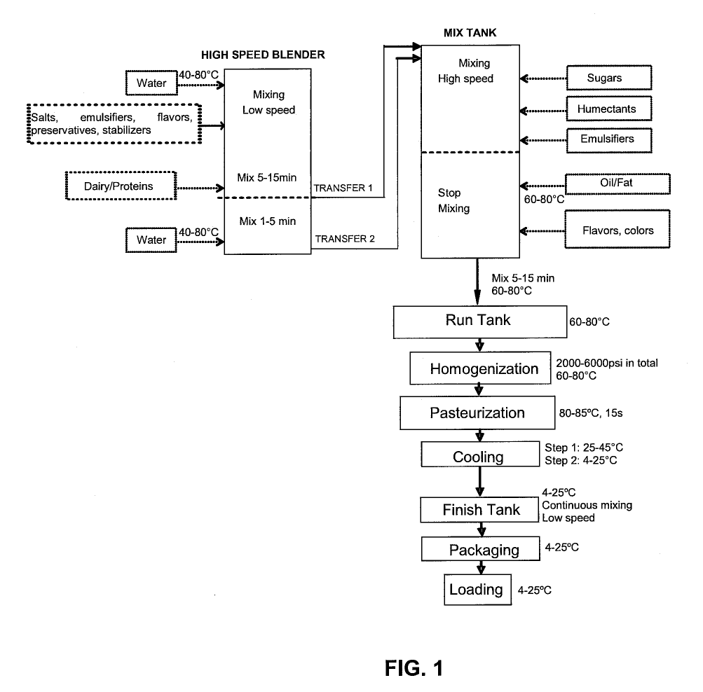

Referring now to the drawing wherein the showing is for the purpose of illustrating one non-limiting embodiment of the invention only and not for the purpose of limiting the same, FIG. 1 illustrates one non-limiting manufacturing process for manufacturing the pourable dessert base product in accordance with the present invention.

The present invention is directed to a liquid food product and method for manufacturing the liquid food product having an increased refrigerator life and ambient temperature shelf life without having to be UHT processed. The liquid food product is particularly applicable to dairy based liquid food products and will be described with particular reference thereto; however, it will be appreciated that the invention can be applied to liquid food products that do not contain dairy ingredients. The invention is also directed to a high solids content pourable dessert base product that has at least 45-75% of total solids content, that is ready-to-dilute with purified water and ready-to-mix with additional ingredients (e.g., milk, cream, flavors, extracts, liquors, etc.) for a customizable final flavor and sweetness, that has increased refrigerator shelf life and ambient temperature shelf life, and that does not require to be UHT processed or to be stored at freezing temperature. The product is a new ready-to-use product that overcomes this problem without having to UHT process the product.

The protein source can include dried skim milk, whey protein, milk protein concentrate, caseinate, soy protein isolate, soy protein concentrate, and the like. One non-limiting protein source includes dried skim milk and/or caseinate.

The oil/fat can include soy bean oil, sunflower oil, canola oil, modified canola oil, palm kernal oil, coconut oil, dairy fats, dairy cremes and the like. One non-limiting oil/fat includes palm kernal oil and/or coconut oil.

The sweetener can include sucrose, corn syrup (e.g., dextrose and/or high fructose corn syrup), artificial sweeteners, low or no calorie sweeteners, and the like. One non-limiting sweetener includes sucrose and/or corn syrup.

The humectant can include glycerin, sorbitol, and the like. One non-limiting humectant includes glycerin.

The stabilizer can include carrageenan, guar gum, locust bean gum, xanthan gum, cellulose, modified cellulose, hydrocolloids, and the like. One non-limiting stabilizer includes carrageenan and/or xanthan gum.

The favors can include condensed milk, vanilla, Kahlua, coffee, mocha, raspberry, strawberry, citrus, fruit, liqueur flavor and the like. One non-limiting flavor includes condensed milk and/or vanilla.

The emulsifier can include polysorbate (e.g., polysorbate 60 and/or polysorbate 80), sodium stearyl lactylate, calcium stearyl lactylate, monoglyceride, diglyceride, hexaglycal distearyte, and the like. One non-limiting emulsifier includes polysorbate, mono or diglycerides and/or sodium stearyl lactylate.

The liquid dessert concentrate can be mixed with various foods, liquids or flavorings, including eggs, cinnamon, coffee, cappuccino, coffee liqueur, coconut, nuts, chocolate, rum, and flavored mixes such as margarita, daiquiri, pina colada, etc. The liquid dessert concentrate can be also or alternatively mixed with fruit or fruit toppings, such as strawberries, peaches, pineapples, mangoes and the like, or fruit products, such as conserves, marmalade and the like. The liquid dessert concentrate may also or alternatively comprise a topping, including dairy or non-diary whipped toppings, nuts (e.g., hazelnut, etc.) coconut, cinnamon and/or chocolate.

Dessert cakes containing the liquid dessert concentrate may be prepared by soaking a suitable cake with an appropriate amount by weight of the pourable dessert liquid mix. Suitable cakes include but are not limited to sponge cakes, layer cakes, sheet cakes, half sheet, and quarter sheet cakes.

Referring now to FIG. 1, there is one non-limiting process for manufacturing the liquid food product of the present invention. Water, milk, salt and other optional additives (e.g., phosphates, citrates, mono and/or diglycerides, flavorings, gums (e.g., xanthan gum, etc.), carrageenan, etc.) are mixed together at a temperature of about 40-80° C. at a slow speed (e.g., 50-500 rpm) for about 1-15 minutes to form a first solution. Thereafter, additional additives are added (e.g., HFCS, sweetener, glycerin, polysorbate, oil and/or fat, vitamins, flavorings, etc.) to the first solution to form a second solution. The first solution can be optionally transferred to another mixing tank for the mixing of the additional additive. The additional additives are generally added and/or mixed with the first solution at a temperature of about 40-80° C. at a higher speed than the mixing of the first solution (e.g., 200-1000 rpm) for about 1-15 minutes to form a second solution. The second solution is thereafter optionally homogenized and/or pasteurized, and then cooled to a temperature of 4-25° C. The cooling process can be a two-step process to improve the stability of the liquid food product. In one non-limiting cooling step, the second solution is first cooled to a temperature of about 25-45° C., and then is cooled to a temperature of about 4-25° C. After the cooling process, the second solution is transferred to a finishing tank wherein the second solution is stirred at a low speed (e.g., 50-500 rpm) for about 1-15 minutes. Thereafter, the second solution is packaged at a temperature of about 2-10° C. Thereafter, the packaged liquid food product can be refrigerated at about 0-10° C. or stored at amebient temperature (e.g., 22-28° C.).

It will thus be seen that the objects set forth above, among those made apparent from the preceding description, are efficiently attained, and since certain changes may be made in the constructions set forth without departing from the spirit and scope of the invention, it is intended that all matter contained in the above description and shown in the accompanying drawings shall be interpreted as illustrative and not in a limiting sense. The invention has been described with reference to preferred and alternate embodiments. Modifications and alterations will become apparent to those skilled in the art upon reading and understanding the detailed discussion of the invention provided herein. This invention is intended to include all such modifications and alterations insofar as they come within the scope of the present invention. It is also to be understood that the following claims are intended to cover all of the generic and specific features of the invention herein described and all statements of the scope of the invention, which, as a matter of language, might be said to fall therebetween. The invention has been described with reference to the preferred embodiments. These and other modifications of the preferred embodiments as well as other embodiments of the invention will be obvious from the disclosure herein, whereby the foregoing descriptive matter is to be interpreted merely as illustrative of the invention and not as a limitation. It is intended to include all such modifications and alterations insofar as they come within the scope of the appended claims.

We claim:

1. A liquid dessert concentrate that can be stored in a non-refrigerated environment for at least 5 days without spoilage comprising by weight percent:

| | |
|---|---|
| Water | 10-60% |
| Salt | up to 8% |
| Emulsifier | up to 5% |
| Stabilizer | up to 5% |
| Dairy/Protein | 3-25% |
| Sweetener | 1-65% |
| Humectant | up to 7% |
| Oil/Fat | 2-25% |
| Coloring | up to 1% |
| Flavor | up to 5% |
| Preservative | up to 1%, |

and wherein said liquid dessert concentrate is homogenized, pasteurized, or combinations thereof and has a water activity of less than 0.95.

2. The liquid dessert concentrate as defined in claim 1, comprising by weight percent:

| | |
|---|---|
| Water | 15-50% |
| Salt | up to 5% |
| Emulsifier | up to 4% |
| Stabilizer | up to 4% |
| Dairy/Protein | 5-20% |
| Sweetener | 10-40% |
| Humectant | up to 5% |
| Oil/Fat | 5-20% |
| Color | up to 1% |
| Flavor | up to 4% |
| Preservative | up to 0.3%. |

3. The liquid dessert concentrate as defined in claim 1, comprising by weight percent:

| | |
|---|---|
| Water | 15-30% |
| Salt | up to 3% |
| Emulsifier | up to 2% |
| Stabilizer | up to 2% |
| Dairy/Protein | 8-20% |
| Sweetener | 15-35% |
| Humectant | up to 4% |
| Oil/Fat | 8-15% |
| Color | up to 1% |
| Flavor | up to 4% |
| Preservative | up to 0.3%. |

4. The liquid dessert concentrate as defined in claim 1, comprising by weight percent:

| | |
|---|---|
| Water | 20-40% |
| Salt | less than 1%, but greater than 0% |
| Emulsifier | less than 1%, but greater than 0% |
| Stabilizer | less than 1%, but greater than 0% |
| Dairy/Protein | 5-15% |
| Sugar | 25-60% |
| Humectant | up to 4% |
| Oil/Fat | 5-15% |
| Color | less than 0.5% |
| Flavor | less than 0.5% |
| Preservative | less than 0.1%. |

5. The liquid dessert concentrate as defined in claim 1, comprising by weight percent:

| | |
|---|---|
| Water | 10-40% |
| Salt | up to 1% |
| Emulsifier | up to 2% |
| Stabilizer | up to 1% |
| Dairy/Protein | 5-15% |
| Sweetner | 30-60% |
| Humectant | up to 5% |
| Oil/Fat | 2-17% |
| Color | up to 0.5% |
| Flavor | up to 1% |
| Preservative | up to 0.5%. |

6. The liquid dessert concentrate as defined in claim 1, comprising by weight percent:

| | |
|---|---|
| Purified water | 20-40% |
| Refined salt (e.g., NaCl) | less than 1%, but greater than 0% |
| Dipotassium Phosphate | less than 1%, but greater than 0% |
| Sodium Citrate | less than 1%, but greater than 0% |
| Mono-diglycerides | less than 1%, but greater than 0% |
| Carrageenan | less than 1%, but greater than 0% |
| Skim Milk Powder | 5-15% |
| Polysorbate 60 | less than 1%, but greater than 0% |
| HFCS 42 | 20-40% |
| Glucose 36 DE | 5-15% |
| Glycerin | 0-5% |
| Pam Oil | 5-15% |
| Beta-carotene 30% | less than 0.5%, but greater than 0% |
| Flavor | less than 0.5%, but greater than 0% |
| Flavor masking | less than 0.5%, but greater than 0% |
| Natamycin | less than 0.1%, but greater than 0%. |

7. The liquid dessert concentrate as defined in claim 1, comprising by weight percent:

| | |
|---|---|
| Water | 25-30% |
| Salt | less than 1%, but greater than 0% |
| Emulsifier | less than 1%, but greater than 0% |
| Stabilizer | less than 1%, but greater than 0% |
| Dairy | 10-15% |
| Emulsifier | less than 0.5%, but greater than 0% |
| Sugar | 35-50% |
| Oil/Fat | 10-15% |
| Color | less than 0.5%, but greater than 0% |
| Flavor | less than 0.5%, but greater than 0% |
| Preservative | less than 0.1%, but greater than 0%. |

8. The liquid dessert concentrate as defined in claim 1, comprising by weight percent:

| | |
|---|---|
| Purified water | 25-30% |
| Refined salt (e.g., NaCl) | less than 1%, but greater than 0% |
| Dipotassium Phosphate | less than 1%, but greater than 0% |
| Sodium Citrate | less than 1%, but greater than 0% |
| Mono-diglycerides | less than 1%, but greater than 0% |
| Carrageenan | less than 1%, but greater than 0% |
| Skim Milk Powder | 10-15% |
| Polysorbate 60 | less than 0.5%, but greater than 0% |
| HFCS 42 | 25-30% |
| Glucose 36 DE | 10-15% |
| Glycerin | up to 5%, but greater than 0% |
| Pam Oil | 10-15% |
| Beta-carotene 30% | less than 0.5%, but greater than 0% |
| Flavor | less than 0.5%, but greater than 0% |
| Flavor masking | less than 0.5%, but greater than 0% |
| Natamycin | less than 0.1%, but greater than 0%. |

9. The liquid dessert concentrate as defined in claim 1, comprising by weight percent:

| | |
|---|---|
| Water | 25-28% |
| Salt | less than 0.8% |
| Emulsifier | less than 0.8% |
| Stabilizer | less than 0.8% |
| Dairy | 12-15% |
| Sugar | 25-50% |
| Humectant | up to 4% |
| Oil/Fat | 10-15% |
| Color | less than 0.4% |
| Flavor | less than 0.4% |
| Preservative | less than 0.1%. |

10. The liquid dessert concentrate as defined in claim 1, comprising by weight percent:

| | |
|---|---|
| Purified water | 25-28% |
| Refined salt (e.g., NaCl) | less than 0.8% |
| Dipotassium Phosphate | less than 0.8% |
| Sodium Citrate | less than 0.8% |
| Mono-diglycerides | less than 0.8% |
| Carrageenan | less than 0.8% |
| Skim Milk Powder | 12-15% |
| Polysorbate 60 | less than 0.45% |
| HFCS 42 | 25-30% |
| Glucose 36 DE | 10-15% |
| Glycerin | 0-5% |
| Pam Oil | 10-15% |
| Beta-carotene 30% | less than 0.4% |
| Flavor | less than 0.4% |
| Flavor masking | less than 0.4% |
| Natamycin | less than 0.1%. |

11. The liquid dessert concentrate as defined in claim 1, comprising by weight percent:

| | |
|---|---|
| Water | 18-38% |
| Salt | less than 3% |
| Emulsifier | less than 1% |
| Stabilizer | less than 2% |
| Dairy/Protein | 5-15% |
| Emulsifier | less than 1% |
| Sugar | 27-57% |
| Humectant | 0-5% |
| Oil/Fat | 6-16% |
| Color | less than 0.5% |
| Flavor | less than 0.5% |
| Flavor Masking | less than 0.5% |
| Preservative | less than 0.1%. |

12. The liquid dessert concentrate as defined in claim 1, comprising by weight percent:

| | |
|---|---|
| Purified water | 18-38% |
| Refined salt | less than 1%, but greater than 0% |
| Dipotassium Phosphate | less than 1%, but greater than 0% |
| Sodium Citrate | less than 1%, but greater than 0% |
| Mono-diglyceriedes | less than 1%, but greater than 0% |
| Carrageenan | less than 1%, but greater than 0% |
| Xanthan gum | less than 1%, but greater than 0% |
| Skim Milk Powder | 5-15% |
| Polysorbate 60 | less than 1%, but greater than 0% |
| HFCS 42 | 19-39% |
| Glucose 36 DE | 8-18% |
| Glycerin | up to 5%, but greater than 0% |
| Palm Kernel Oil | 6-16% |
| Beta-carotene 30% | less than 0.5%, but greater than 0% |
| Milk Flavor | less than 0.5%, but greater than 0% |
| Masking Flavor | less than 0.5%, but greater than 0% |
| Natamycin | less than 0.1%, but greater than 0%. |

13. The liquid dessert concentrate as defined in claim 1, comprising by weight percent:

| | |
|---|---|
| Water | 23-43% |
| Salt | less than 3% |
| Emulsifier | less than 1% |
| Stabilizer | less than 2% |
| Dairy/Protein | 5-15% |
| Emulsifier | less than 1% |
| Sugar | 38-58% |
| Humectant | 0-5% |
| Oil/Fat | 0-10% |
| Color | less than 0.5% |
| Flavor | less than 0.5% |
| Flavor Masking | less than 0.5% |
| Preservative | less than 0.1%. |

14. The liquid dessert concentrate as defined in claim 1, comprising by weight percent:

| | |
|---|---|
| Purified water | 23-43% |
| Refined salt | less than 1%, but greater than 0% |
| Dipotassium Phosphate | less than 1%, but greater than 0% |
| Sodium Citrate | less than 1%, but greater than 0% |
| Mono-diglycerides | less than 1%, but greater than 0% |
| Carrageenan | less than 1%, but greater than 0% |
| Xanthan gum | less than 1%, but greater than 0% |
| Skim Milk Powder | 5-15% |
| Polysorbate 60 | less than 1%, but greater than 0% |
| Sucrose | 38-58% |
| Glycerin | up to 5%, but greater than 0% |
| Palm Kermel Oil | up to 10%, but greater than 0% |
| Beta-carotene 30% | less than 0.5%, but greater than 0% |
| Milk Flavor | less than 0.5%, but greater than 0% |
| Masking Flavor | less than 0.5%, but greater than 0% |
| Natamycin | less than 0.1%, but greater than 0%. |

15. The liquid dessert concentrate as defined in claim 1, wherein said liquid dessert concentrate has a viscosity of 500-2000 cps.

16. The liquid dessert concentrate as defined in claim 1, wherein said liquid dessert concentrate has a total solids of 55-75%.

17. The liquid dessert concentrate as defined in claim 1, wherein said liquid dessert concentrate has an acidic pH.

18. The method for forming a liquid dessert concentrate that can be stored in a non-refrigerated environment for at least 5 days without spoilage comprising the steps of:
a. mixing together water, protein/dairy, salt and optionally one or more additives selected from the group consisting of monoglyceride, diglyceride, flavor, gum and carrageenan, said mixing at a temperature of 35-90° C. for about 0.5-20 minutes to form a first solution;
b. mixing sweetener, oil/fat and optionally one or more secondary additives selected from the group consisting of emulsifier, stabilizer, humectant, color, flavor, vitamins, and preservative to said first solution to form a second solution, said mixing at a temperature of 40-90° C. for about 0.5-40 minutes to form a second solution;
c. optionally homogenizing, pasteurizing or combinations thereof of said second solution;
d. cooling said second solution to a temperature of 0-30° C.;
e. stirring second solution for at least about 0.1 minutes to form said liquid dessert concentrate; and,
f. packaging said liquid dessert concentrate.

19. The method as defined in claim 18, wherein said liquid dessert concentrate comprises by weight percent:

| | |
|---|---|
| Water | 10-60% |
| Salt | up to 8% |
| Emulsifier | up to 5% |
| Stabilizer | up to 5% |
| Dairy/Protein | 3-25% |
| Sweetener | 1-65% |
| Humectant | up to 7% |
| Oil/Fat | 2-25% |
| Coloring | up to 1% |
| Flavor | up to 5% |
| Preservative | up to 1%, |

and wherein said liquid dessert concentrate is homogenized, pasteurized, or combinations thereof and has a water activity of less than 0.95.

20. The method as defined in claim 18, wherein said liquid dessert concentrate comprises by weight percent:

| | |
|---|---|
| Water | 10-40% |
| Salt | up to 1% |
| Emulsifier | up to 2% |
| Stabilizer | up to 1% |
| Dairy/Protein | 5-15% |
| Sweetner | 30-60% |
| Humectant | up to 5% |
| Oil/Fat | 2-17% |
| Color | up to 0.5% |
| Flavor | up to 1% |
| Preservative | up to 0.5% |

and wherein said liquid dessert concentrate is homogenized, pasteurized, or combinations thereof and has a water activity of 0.82-0.92, a pH of 5.7-7.5, a viscosity of 500-2000 cPs, and a total solids content of 45-75%.

21. The method as defined in claim 18, wherein said step of mixing to form said first solution occurs at a temperature of about 40-80 C at a speed of about 50-500 rpm for about 1-15 minutes.

22. The method as defined in claim 18, wherein said step of mixing to form said second solution occurs at a temperature of about 60-80 C at a speed of about 200-1000 rpm for about 1-15 minutes, said speed of mixing said second solution is greater than said mixing speed of said first solution.

23. The method as defined in claim 18, wherein said step of cooling occurring by a multi-step process, said second solution initially cooled to a temperature of about 25-45° C., and then said second solution is cooled to a temperature of about 4-25° C.

24. The method as defined in claim 18, wherein said step of stirring occurring at a speed of about 50-500 rpm for about 1-15 minutes.

25. The method as defined in claim 18, wherein said step of packaged occurring at a temperature of about 0-25° C.

26. The method as defined in claim 18, including the said step of refrigerating said packaged liquid food product at about 0-10° C.
